(19) United States
(12) Patent Application Publication
(10) Pub. No.: US 2007/0135121 A1
(43) Pub. Date: Jun. 14, 2007

(54) User and service mobility support system and method in ubiquitous environment

(75) Inventors: Jung-Sook Bae, Daejeon-city (KR); Sook-Yang Kang, Daejeon-city (KR); Gyung-Chul Shin, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/635,552

(22) Filed: Dec. 8, 2006

(30) Foreign Application Priority Data
Dec. 8, 2005 (KR) 10-2005-0119892
Apr. 24, 2006 (KR) 10-2006-0036575

(51) Int. Cl. H04Q 7/20

(52) U.S. Cl. 455/432.1; 455/435.2; 370/331; 709/224

(57) ABSTRACT

A user and service mobility support system and method of in a ubiquitous environment is provided. When a user moves to a domain area capable of using various service equipment by pursuing a location of a user using a mobile communication service outdoors, the user may continuously use a service by determining service equipment based on the user's preference information, available equipment information, and service characteristic information. The user may continuously use a service through various equipments although the user moves into the domain area while the user has used a mobile communication service through the terminal outdoors. In order to select service equipment from among various media equipment, the optimum service equipment is determined based on the user and service characteristic information, and accordingly, it is possible to provide service movement convenience and satisfaction to the user.

### BACKGROUND OF THE INVENTION

(a) Field of the Invention

The present invention relates to a service mobility support method, and more particularly, the present invention relates to a user and service mobility support system and method in a ubiquitous environment.

(b) Description of the Related Art

A ubiquitous paradigm has appeared such that a user uses desired and optimum information though the user's periphery optimum equipment whenever and wherever, and accordingly, a ubiquitous computing environment for supporting a service has been configured. In such an environment, a method for supporting user mobility considering user's various context and service characteristics is desired so as to provide a seamless service without the user's discomfort.

As the prior art, the Korean publication No. 10-2005-0039070, entitled “A User Mobility Support System and Method for using a Bluetooth-based PDA (Personal Digital Assistant)” is disclosed. The prior art discloses that when a user moves to other locations while using multimedia contents such as video using the Bluetooth-based PDA at home or the office and the user wants to continuously uses the using multimedia contents regardless of the movement, the user continuously uses the contents though the PDA by using the system resources of the moved-to location.

In order to support user mobility in the ubiquitous environment, it is important that appropriate service equipment is selected by the user's minimum try based on various context information such as user's equipment preference, user location, available equipment information, and service characteristics, and an appropriate media application is performed for the equipment. However, the prior art does not disclose that a service is provided considering the user's various context and service characteristics. The user-carried Bluetooth-based PDA is continuously used to provide a seamless service. Accordingly, it is desired that the optimum user and service mobility is more efficiently supported in the ubiquitous environment.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a user and service mobility support system and method in a ubiquitous environment having advantages of using a service through more various media equipment under a moved domain area environment when a user moves into a domain area environment such as home or the office while the user uses a mobile communication service through a terminal having a cellular communication function and a near field communication function. In addition, the present invention has been made in an effort to provide a user and service mobility support system and method in a ubiquitous environment having advantages of continuously providing a mobile communication service by selecting the optimum media equipment considering user's various context and service characteristics including a user's location under a domain area environment.

An exemplary embodiment of the present invention provides a user and service mobility support method of a mobility support system when a user moves into a second network of a ubiquitous environment including a plurality of service equipment while the user uses a service through a mobile terminal in a first network, the user and service mobility support method including: (a) the system sensing that the mobile terminal enters from the first network into the second network and receiving user and service information from the mobile terminal so as to provide a service to the plurality of service equipment; (b) selecting a first service equipment from among the plurality of service equipment based on user context information, service context information, and user location information; and (c) processing service data provided from the mobile terminal and then providing a service through the selected first service equipment.

Another exemplary embodiment of the present invention provides a user and service mobility support system for supporting a user and service mobility when a user moves into a second network of a ubiquitous environment including a plurality of service equipment while the user uses a service through a mobile terminal in a first network, the user and service mobility support system including: a domain server for authenticating the user that has entered into the second network by interworking with the first network, controlling a service movement based on user context information, service context information, and user location information, and determining one service equipment from among the plurality of service equipment; a media application server for converting service data so as to provide the service to the one service equipment determined by the domain server; a location recognition server for providing physical location information by sensing the user's location; and a location management server for receiving the physical location information from the location recognition server, managing the user's location information identified by the local location information, and providing the user's location information to the domain server.

### BRIEF DESCRIPTION OF THE DRAWINGS

FIG. 1 schematically illustrates a user and service mobility support system in a ubiquitous environment according to an exemplary embodiment of the present invention.

FIG. 2 is block diagram of a multi-mode mobile terminal according to an exemplary embodiment of the present invention.

FIG. 3 schematically illustrates a service mobility support system according to an exemplary embodiment of the present invention.

FIG. 4 is a flowchart showing a message flow and operation when a user having a portable multi-mode mobile terminal enters into a domain area network according to a first exemplary embodiment of the present invention.

FIG. 5 is a flowchart showing a message flow and operation when a user leaves a domain area network according to a second exemplary embodiment of the present invention.

FIG. 6 is a flowchart showing a message flow and operation when a user moves in a domain area network according to a second exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is coupled to another element, the element may be directly coupled to the other element or coupled to the other element through a third element.

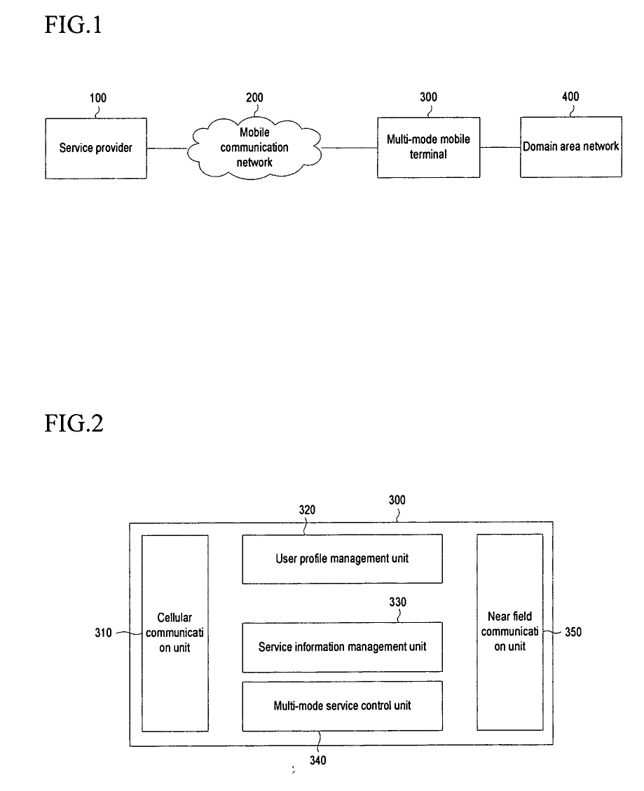

FIG. 1 schematically illustrates a user and service mobility support system in a ubiquitous environment according to an exemplary embodiment of the present invention.

As shown in FIG. 1, a network includes a service provider 100, a mobile communication network 200, a multi-mode mobile terminal 300, and a domain area network 400.

The service provider 100 provides a service when a user wants to use it through the multi-mode mobile terminal 300 connected to the mobile communication network 200 or the domain area network 400. The multi-mode mobile terminal 300 is a mobile communication terminal for supporting a service such as CDMA 1x/EV-DO, but is not limited thereto.

When the user moves from the mobile communication network 200 to the domain area, the multi-mode mobile terminal 300 is connected to the domain area network 400, and accordingly, it provides a service to the user. The term “domain area” means a home domain, which is a fixed environment such as a home area, an office domain, which is an office room area, and a local area such as a car domain, which is a user's movement environment, and it may have a service mobility support system disposed therein.

When the user uses a service through the multi-mode mobile terminal 300 connected to the mobile communication network 200 and then the user moves from the mobile communication network 200 to the domain area, the multi-mode mobile terminal 300 is connected to the domain area network 400, and the user may use a seamless service. The multi-mode mobile terminal 300 is described with reference to FIG. 2.

FIG. 2 is block diagram of a multi-mode mobile terminal according to an exemplary embodiment of the present invention.

As shown in FIG. 2, the multi-mode mobile terminal includes a cellular communication unit 310, a near field communication unit 350, a user profile management unit 320, a service information management unit 330, and a multi-mode service controller 340.

The cellular communication unit 310 performs a communication function between the multi-mode mobile terminal 300 and the mobile communication network 200. That is, when the user is provided with a service through the mobile communication network 200, which is provided by the service provider 100 before the user enters into the domain area network 400, the cellular communication unit 310 performs a communication function between the user-carried multi-mode mobile terminal 300 and the mobile communication network 200.

The near field communication unit 350 performs a near field communication function in the domain area network 400. That is, in order to continuously provide a service to the user when the user using an external service moves into the domain area network 400, the near field communication unit 350 performs a communication function to the user-carried multi-mode mobile terminal.

The user profile management unit 320 stores user context information such as the user's service mobility preference items and equipment preference items. At this time, the user profile is profile information that are input through the terminal according to the user's request and user profile information collected whenever the user uses a service.

The service information management unit 320 manages a user-using mobile communication service list and characteristics of each service. At this time, the service information is provided from a service portal connected so as to use a service. That is, the service provider 100 previously registers characteristics of to-be provided service on the service portal, and the user uses a service from the several services through the service portal.

The multi-mode service controller 340 performs an exchange of service data signals or service control signals between the cellular communication unit 310 and the near field communication unit 350.

That is, if the multi-mode mobile terminal 300 is operated in a multi-mode, the service controller 340 changes a packet provided through the cellular communication into a format appropriate for the near field communication, or changes a packet provided through the near field communication into a format appropriate for the cellular communication.

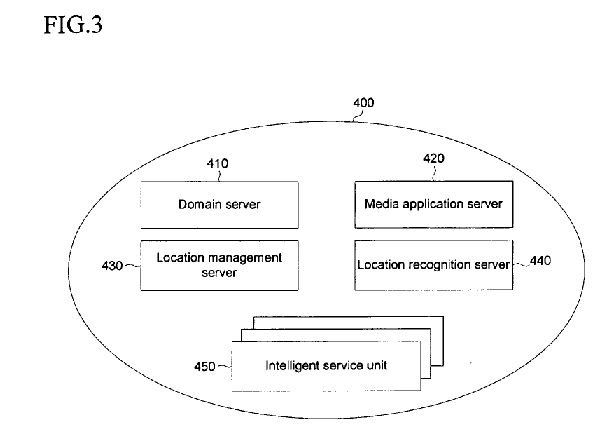

How to continuously use a service when the user using a service through the multi-mode mobile terminal 300 moves to the domain area network 400 is described in detail with reference to FIG. 3 to FIG. 6.

FIG. 3 schematically illustrates a service mobility support system according to an exemplary embodiment of the present invention.

As shown in FIG. 3, the service mobility support system includes a domain server 410, a media application server 420, a location management server 430, a location recognition server 440, and an intelligent service unit (or a service unit) 450.

The domain server 410 includes a home server, an office server, and a car server, and identifies a user that has entered into the domain area and authenticates the user and gathers user's context information and available equipment information. In addition, the domain server 410 receives user location information from the location management server 430. At this time, it determines an optimum intelligent service unit 450 for continuously providing a user-using service based on the user location information, the user's equipment preference items, the user's location, the available equipment information, and the service characteristic information.

The media application server 420 provides service data to the intelligent service unit 450 while the service data are transcoded in a format appropriate for the optimum intelligent service unit 450 determined by the domain server 410. That is, since the intelligent service unit 450 has various service support capabilities for all service equipment, the media application server 420 transforms the service provided to the multi-mode mobile terminal 300 in a format appropriate for the corresponding intelligent service unit.

When it is requested that a location of the user authenticated by the domain server 410 is pursued in real-time, the location management server 430 identifies user's physical locations recognized by the location recognition server 440 as local location information and manages the same. At this time, the information is transmitted to the domain server 410 such that the user may continuously use a service through the optimum intelligent service unit 450.

The location recognition server 440 senses user's physical location, and may utilize various inner location recognition means such as RFID (Radio Frequency Identification), ultrasonic waves, and Bluetooth. For example, the RFID is used to sense a location of a user-carried RFID tag, and the ultrasonic waves are irradiated to the user and the user physical location may be sensed by reflected waves of the irradiated ultrasonic waves.

The intelligent service unit 450 has a near field communication capability and a multimedia service support capability such as WLAN (wireless local area network), Bluetooth, UWB (ultra wideband), and 802.14.¾ in the domain area network 400, and may include various information on home appliances having a communication capability. That is, when the multi-mode mobile terminal 300 receiving a service by being connected to the mobile communication network 200 enters into the domain area network 400, the multi-mode mobile terminal 300 may continuously receive a service through the intelligent service unit 450 in the domain area.

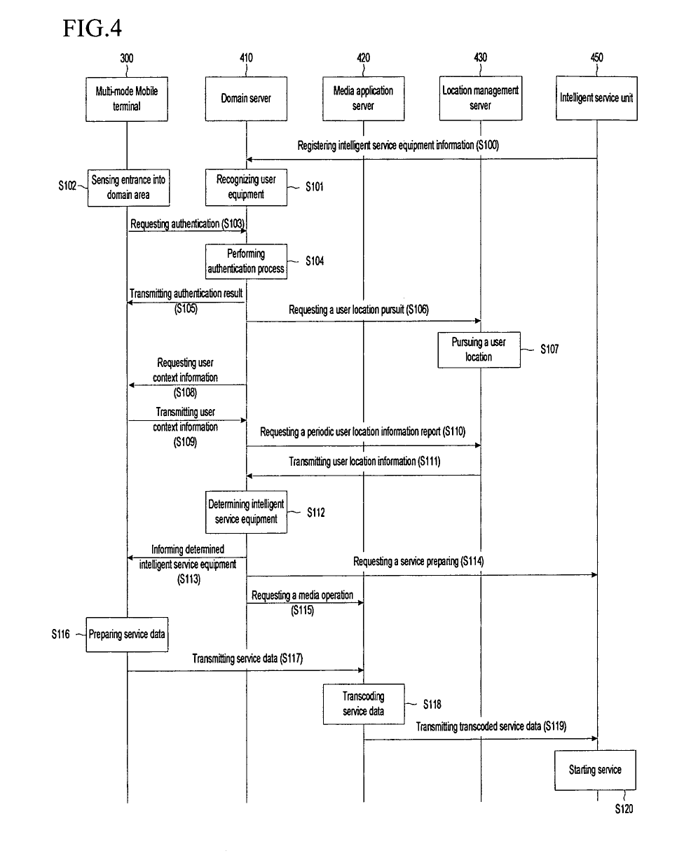

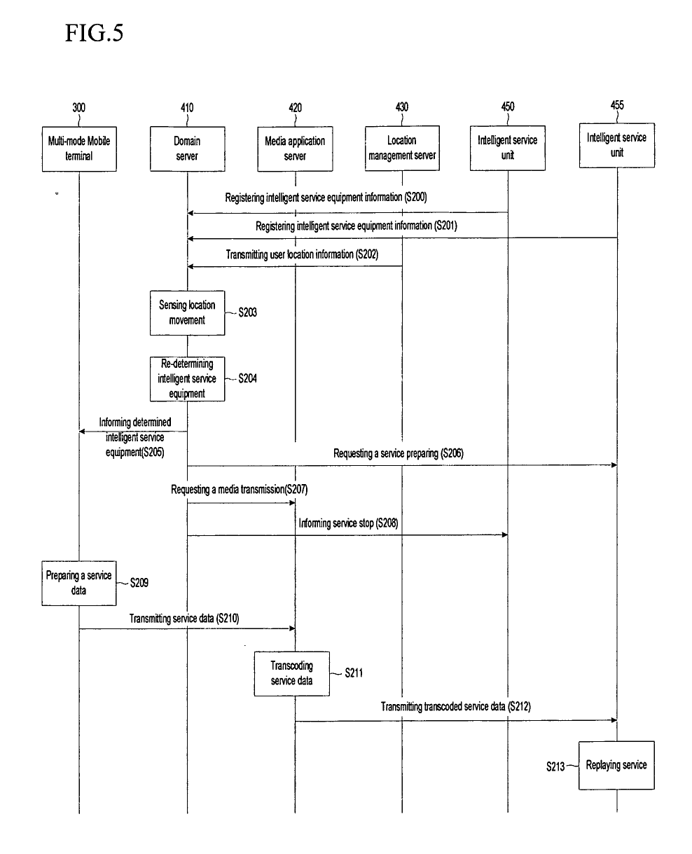

How to support a user and service mobility in a ubiquitous environment is described in detail with reference to FIG. 4 to FIG. 6.

FIG. 4 is a flowchart showing a message flow and operation when a user having a portable multi-mode mobile terminal enters into a domain area network according to a first exemplary embodiment of the present invention.

As shown in FIG. 4, in order to continuously provide a service even after the user carrying a multi-mode mobile terminal enters into the domain area network, equipment information such as equipment capability, whether to provide service, and equipment availability about a plurality of intelligent service units 450 in the domain area network 400 are periodically registered on the domain server 410 (S100).

When the user moves into the domain area network 400 while the user uses a mobile communication service through the multi-mode mobile terminal 300 outdoors, the multi-mode mobile terminal 300 recognizes a beacon signal of a line layer output from the domain server 410 and senses the entrance into a new domain area (S102).

The beacon signal of the line layer includes information about which cell the access point (AP) manages. According to an exemplary embodiment of the present invention, this means domain area information of the AP for managing a domain area. That is, the multi-mode mobile terminal 300 may recognize that it is connected to the new domain area network 400 when an L2 trigger stands. The multi-mode mobile terminal 300 receives an identifier for identifying the AP of the domain area network 400 from the AP.

The multi-mode mobile terminal 300 recognizes a beacon signal, and the domain server 410 simultaneously recognizes a new user and a new user's multi-mode mobile terminal 300 (S101). That is, the multi-mode mobile terminal 300 performs a soft hand-off at the same frequency having other pseudo noise offsets, and accordingly, the domain server 410 may recognize an entrance of the multi-mode mobile terminal 300 (S101). The above-noted entrance recognition of the inter-network movement of the multi-mode mobile terminal 300 is well known. Accordingly, a detailed description will be omitted.

The multi-mode mobile terminal 300 senses an entrance into the new domain area network 400 (S102) and requests the domain server 410 to authenticate a user (S103), and the domain server 410 performs a user authentication process (S104) and transmits an authentication result to the multi-mode mobile terminal 300 (S105).

At this time, the user authentication is performed by the domain server 410 gathering user information and transmitting the gathered user information to the mobile communication network 200. The mobile communication network 200 authenticates the user that has entered into the new domain area network 400 based on the user information received from the domain server 410, and transmits an authentication result to the domain server 410.

The domain server 410 requests the location management server 430 to pursue an authenticated user location in real-time (S106). The location management server 430 receives a user's physical location information from the location management server 440, converts the same into logical location information, and continuously manages a user location (S107).

The domain server 410 requests the user profile management unit 320 and service information management unit 330 to transmits user context information and service context information managed by the multi-mode mobile terminal 300 (S108). The user context information includes user's service mobility preference items and user's equipment preference items, and the service context information includes a user-using mobile communication service list and each service characteristic.

When the user profile management unit 320 and the service information management unit 330 receive a user and service context information request message from the domain server 410, they transmit the stored user context information and service context information to the domain server 410 (S109).

The domain server 410 analyzes user preference items transmitted from the user profile management unit 320. At this time, when it is determined that the user wants to move a service and there is a user-using mobile communication service based on the analyzed information, the domain server 410 requests the location management server 430 to periodically transmit user location information (S110). When the domain server 410 requests the location management server 430 to pursue a user's location, the location management server 430 periodically transmits self-managed user location information to the domain server 410 (S111).

When the domain server 410 receives the user location information, it determines optimum intelligent service equipment based on the present user location information, the user preference information, the periphery available intelligent service equipment information of the user's location, and the user-using service characteristic information (S112).

How the domain server 410 determines optimum intelligent service equipment will now be described. Firstly, when the user A moves into the domain area network 400 while using a motion picture service in the mobile communication network 200, the domain server 410 authenticates the user A and requests the location management server 430 to provide the present user location information. The domain server 410 receives user context information of the user A and service context information of the motion picture service being used from the multi-mode mobile terminal 300.

The domain server 410 searches the peripheral available intelligent service equipment of the user A's location based on the user A's location information transmitted from the location management server 430. When the searched available intelligent service equipment is given as the radio and television, the domain server 410 selects a television as the optimum intelligent service equipment for the user A based on the user context information and service context information transmitted from the multi-mode mobile terminal 300, and continuously provides a motion picture service.

After the domain server 410 determines an optimum intelligent service unit 450 as described above, the domain server 410 informs it of the multi-mode mobile terminal 300 that the optimum intelligent service unit 450 for supporting a service movement is determined (S113) and requests the determined intelligent service unit 450 to perform initialization and application programs for providing a service (S114).

Then, the multi-mode mobile terminal 300 informs the user-using service media type and a codec type of the media application server 420, the codec type being what the determined intelligent service unit 450 may provide, and accordingly, requests the media application server 420 to apply a service by the media appropriate for the intelligent service unit 450 (S115).

When the multi-mode mobile terminal 300 receives confirmation that the service movement device is determined, the multi-mode service controller 340 eliminates a mobile communication protocol header from the mobile communication service packet and the multi-mode mobile terminal 300 prepares service data (S116) and transmits the service data through the near field communication unit 350 to the media application server 420(S117). The media application server 420 performs transcoding of the service data considering the codec type of the selected intelligent service unit 450 (S118) and transmits the transcoded service data to the intelligent service unit 450 (S119), and the intelligent service unit 450 replays the received service data (S120).

In FIG. 4, the message flows and is operated from the external portion into the domain area network. Now, a case in which the user leaves the domain area network while the user in the domain area network uses a service through first intelligent service equipment (or a first service unit) and changes the first service unit into second intelligent service equipment (or a second service unit) is described in detail with reference to FIG. 5.

FIG. 5 is a flowchart showing a message flow and operation when a user departs from a domain area network according to a second exemplary embodiment of the present invention.

As shown in FIG. 5, since a plurality of intelligent service units 450 and 455 of in the domain area network 400 do not know when they provide a service to the user, they periodically transmit the equipment information such as self-equipment capability, whether to provide a service, and equipment availability to the domain server 410 and register the same on the domain server 410 (S200, S201). The location management server 430 periodically transmits the managed user location information to the domain server 410(S202). The period is determined by the domain server 410.

When the domain server 410 senses that the user moves into a location where it is impossible for the presently-using intelligent service equipment 450 to continuously provide a service (S203), it re-determines optimum intelligent service equipment 455 based on the information transmitted periodically from a plurality of intelligent service devices 450 and 455 information, that is, the present user location information, the user preference information, the user location's periphery available intelligent service equipment information, and user-using service characteristic information (S204).

The domain server 410 informs it that the optimum intelligent service equipment of the multi-mode mobile terminal 300 is determined and simultaneously the service provision equipment is changed (S205), and requests the determined intelligent service equipment 455 to perform an initialization and application program for providing a service (S206). This step is for informing that the service is continuously provided to the multi-mode mobile terminal 300 through other service equipment 455 in the domain.

The multi-mode mobile terminal 300 then informs the user-using service media type and a codec type of the media application server 420, the codec type being what the determined intelligent service unit 450 may provide, and accordingly, requests the media application server 420 to apply a service by the media appropriate for the intelligent service unit 450 (S207). After the multi-mode mobile terminal 300 requests the media application server 420 to apply media data (S207), it informs a service disconnection of the previous intelligent service unit 450 (S208).

When the multi-mode mobile terminal 300 receives confirmation that the service movement device is determined, the multi-mode service controller 340 eliminates a mobile communication protocol header from the mobile communication service packet and the multi-mode mobile terminal 300 prepares service data so as to apply service data to the selected intelligent service unit 455 (S209). The multi-mode mobile terminal 300 transmits the service data through the near field communication unit 350 to the media application server 420 (S210). The media application server 420 performs transcoding of the service data considering the codec type of the selected intelligent service unit 455 (S211) and transmits the transcoded service data to the intelligent service unit 455 (S212), and the intelligent service unit 455 replays the received service data (S213).

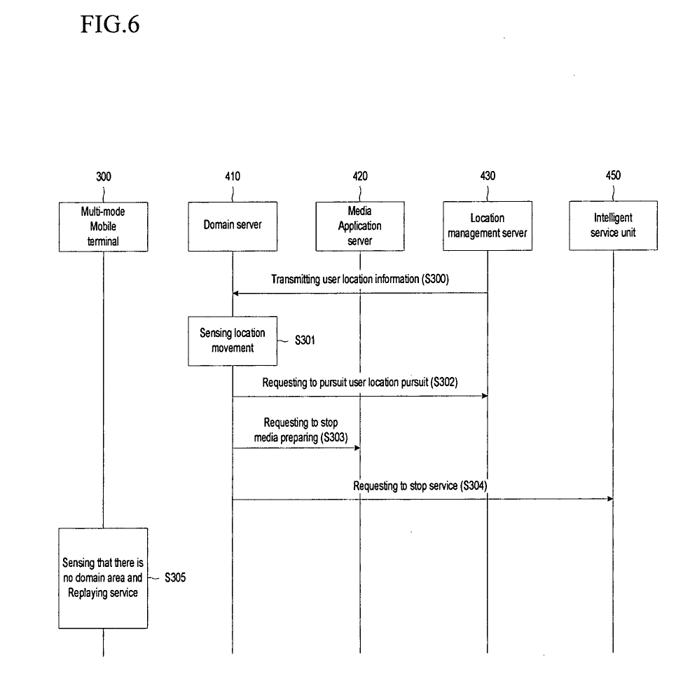

Next, how to provide a service when the user moves into a mobile communication network 100 while the user uses a service through the domain area network 400 is described in detail with reference to FIG. 6.

FIG. 6 is a flowchart showing a message flow and operation when a user moves in a domain area network according to a second exemplary embodiment of the present invention.

As shown in FIG. 6, the location management server 430 periodically transmits the managed user location information to the domain server 410 (S300). When the domain server 410 senses it based on the location information that the user departs from the domain area (S301), it requests the location management server 420 to stop pursuing the corresponding user's location (S302). Herein, how the domain server 410 senses the user's departure from the domain area is the same as explained in FIG. 4. That is, the domain server 410 senses the same by recognizing a beacon signal of the link layer.

After the domain server 410 requests the location management server 420 to stop pursuing the corresponding user's location, it requests the media application server 420 to stop a media application (S303), and informs a service disconnection to the intelligent service unit 450 (S304). When the multi-mode mobile terminal 300 senses that the user departs from of the domain area and moves outdoors by means of checking the line layer connection, the multi-mode mobile terminal 300 provides a service therein (S305).

The above-described methods and apparatuses are not only realized by the exemplary embodiments of the present invention, but, on the contrary, are intended to be realized by a program for realizing functions corresponding to the environment establishment of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, the user may continuously use a service through various equipment although the user moves into a domain area when the user has used a mobile communication service through the terminal outdoors. In addition, in order to select service equipment from among various media equipment, the optimum service equipment is determined based on the user and service characteristic information, and accordingly, it is possible to provide service movement convenience and satisfaction to the user.

In addition, since the service media may be provided appropriately for the service equipment, the same QoS may be provided regardless of the user's movement. In addition, although the user often moves and the service equipment is often changed, a service delay due to a service session configuration may be prevented.

What is claimed is:

1. A user and service mobility support method of a mobility support system when a user moves into a second network of a ubiquitous environment including a plurality of service equipment while the user uses a service through a mobile terminal in a first network, the user and service mobility support method comprising:
(a) the system sensing that the mobile terminal enters from the first network into the second network and receiving user and service information from the mobile terminal so as to provide a service to the plurality of service equipment;
(b) selecting first service equipment from among the plurality of service equipment based on user context information, service context information, and user location information; and
(c) processing service data provided from the mobile terminal and then providing a service through the selected first service equipment.

2. The user and service mobility support method of claim 1, wherein
the (a) sensing and receiving includes
(i) authenticating the mobile terminal by interworking with the first network according to an authentication request message from the mobile terminal having entered the second network, and transmitting an authentication result to the mobile terminal; and
(ii) detecting a user's location by tracking a user's location of the authenticated mobile terminal, and receiving user context information and service context information from the mobile terminal.

3. The user and service mobility support method of claim 2, wherein
the (b) selecting includes
(b-1) gathering the user's location information according to a predetermined period; and
(b-2) determining the first service equipment based on the user's location information and the service context information and user location information transmitted from the mobile terminal, the user context information and service context information including user service mobility preference items, user's equipment preference items, service list, and service characteristics.

4. The user and service mobility support method of claim 1, wherein
the (c) processing and providing includes:
(1) requesting an initialization from the first service equipment so that the first service equipment may receive a service;
(2) receiving service data without a protocol header of the first network from the mobile terminal;
(3) converting the received service data so that the system may provide a service to the first service equipment; and
(4) transmitting the converted service data to the first service equipment.

5. The user and service mobility support method of claim 4, further comprising receiving a codec type of the service data so that the first service equipment may provide the converted service data; and
adapting of the service media so that the first service equipment may provide the converted service data.

6. The user and service mobility support method of claim 1, further comprising when the first service equipment in the second network moves from a first location to a second location:
(d) sensing that the first service equipment has moved;
(e) re-determining a second service equipment disposed at a place into which the first service has moved; and
(f) providing the user service to the user through the re-determined second service equipment, the service being previously provided through the first service equipment.

7. The user and service mobility support method of claim 6, further comprising requesting an initialization from the second service equipment so as to receive a service and adapting a media appropriate for the second service equipment; and
informing the first service equipment of a service stop.

8. The user and service mobility support method of claim 6, further comprising when the system senses that the second service equipment has moved from the second network to the outside of the second network:
(g) stopping a user location tracking on the second service equipment that had received a service from the second network;
(h) stopping a media provision of the service provided through the second service equipment; and
(i) informing the second service equipment of the service provision stop.

9. A user and service mobility support system for supporting a user and service mobility when a user moves into a second network of a ubiquitous environment including a plurality of service equipment while the user uses a service through a mobile terminal in a first network, the user and service mobility support system comprising:
a domain server for authenticating the user having entered the second network by interworking with the first network, controlling a service movement based on user context information, service context information, and user location information, and determining one service equipment among from the plurality of service equipment;
a media adaptation server for converting service data so as to provide the service to the one service equipment determined by the domain server;
a location recognition server for providing physical location information by sensing the user's location; and
a location management server for receiving the physical location information from the location recognition server, managing the user's location information identified as logical location information, and providing the user's location information to the domain server.

10. The user and service mobility support system of claim 9, wherein the mobile terminal connected to the first and second networks and providing a service comprises:
a user profile management unit for storing and managing user context information, the user context information including user's service mobility preference items and user's equipment preference items;
a service information management unit for managing service information including a service list provided to the user from the first network and each service characteristic; and
a multi-mode service controller for converting the using service of the first network in a format adapted to the second network environment and transmitting the converted service, and converting the using service of the second network in a format adapted to the first network environment and transmitting the converted service.
